(19) United States
(12) Patent Application Publication
(10) Pub. No.: US 2008/0150659 A1
(43) Pub. Date: Jun. 26, 2008

(54) Relay Device Using Conductive Fluid

(75) Inventors: Koji Yokoyama, Osaka-shi (JP); Riichi Uotome, Katano-shi (JP); Eiichi Furukubo, Kadoma-shi (JP); Katsumi Kakimoto, Katano-shi (JP); Ryosuke Meshii, Mishima-gun (JP); Hideki Ueda, Shijonawate-shi (JP); Masakazu Kobayashi, Hirakata-shi (JP)

Correspondence Address: Cheng Law Group, PLLC, 1100 17th Street, N.W., Suite 503, Washington, DC, 20036, US

(73) Assignee: Matsushita Electric Works, Ltd., Osaka (JP)

(21) Appl. No.: 11/883,174

(22) PCT Filed: Aug. 29, 2006
(86) PCT No.: PCT/JP2006/016946

§ 371 Date: Jul. 27, 2007

(30) Foreign Application Priority Data
Aug. 31, 2005 (JP) 2005-252200
Aug. 31, 2005 (JP) 2005-252201
Aug. 31, 2005 (JP) 2005-252202
Aug. 31, 2005 (JP) 2005-252209

(51) Int. Cl. H01H 29/00

(52) U.S. Cl. 335/49

(57) ABSTRACT

A relay device using a conductive fluid and having excellent switching response is provided. This relay device mainly comprises a laminate having an interior space, and formed by bonding a semiconductor substrate to an insulating substrate, at least two contacts exposed to the interior space, a diaphragm portion facing the interior space, a conductive fluid sealed in the interior space, and an actuator for elastically deforming the diaphragm portion. By forming the diaphragm portion on the semiconductor substrate, it is possible to reduce a driving force of the actuator needed to elastically deform the diaphragm portion, and obtain a volume change of the interior space with good response. This volume change causes a positional displacement of the conductive fluid in the interior space, thereby forming a conductive state or a non-conductive sate between the contacts.

### TECHNICAL FIELD

The present invention relates to a relay device for opening and closing between contacts by use of a conductive fluid.

### BACKGROUND ART

In recent years, a relay device for opening and closing between contacts by use of a conductive fluid has attracted a lot of interest due to its advantages such as high reliability, low contact resistance, prevention of arc discharge and downsizing, as compared with a conventional relay device.

For example, Japanese Patent Early Publication No. 9-161640 discloses a thermal-driven micro relay device using a conductive fluid such as mercury and germanium. As shown in FIG. 21, this micro relay device is mainly formed with a pair of chambers (10M, 40M), heaters (12M, 42M) disposed in the respective chambers, a channel 20M coupling between the chambers, a liquid metal 50M injected in the channel 20M, a pair of electrodes (30M, 32M) located at a side near the chamber 10M and exposed to the channel 20M, and a pair of electrodes (34M, 36M) located at a side near the chamber 40M and exposed to the channel 20M. For example, when the heater 12M disposed in the chamber 10M is activated, the air in the chamber 10M is heated, so that the internal pressure increases. This increase of the internal pressure allows the liquid metal 50M in the channel 20M to move in a direction toward the chamber 40M, as shown by an arrow in FIG. 21. As a result, a conductive state between the electrodes (34M, 36M) is formed by the liquid metal 50M. On the contrary, when the heater 42M disposed in the chamber 40M is activated, the air in the chamber 40M is heated, so that the internal pressure increases. This increase of the internal pressure allows the liquid metal 50M in the channel 20M to move in a direction toward the chamber 10M. As a result, a conductive state between the electrodes (30M, 32M) is formed by the liquid metal 50M. Thus, the movement of the liquid metal 50M caused by the heated air provides the switching operation. However, due to a delay time required to increase the internal pressure of the chamber after the activation of the hater, there is room for improvement in switching response.

In addition, Japanese Patent Early Publication No. 2004-193133 discloses a switching device with easiness of fabrication. As shown in FIG. 22, this switching device is mainly formed with a channel plate 1N made of a glass material, and comprising a main channel 10N and a plurality of sub channels (20N, 22N) communicated with the main channel, a plurality of contact pads (30N, 32N, 34N) spaced from each other and exposed to the interior of the main channel 10N, a conductive fluid 50N such as mercury injected in the main channel, chambers (40N, 42N) formed at the other ends of the sub channels, driving devices (60N, 62N) such as heat generating means formed in the respective chambers, and a non-conductive driving fluid 70N such as inert gas filled in the sub channels. For example, when the driving device 60N is activated, the driving fluid 70N is pushed out from the sub channel 20N into the main channel 10N, as shown by an arrow in FIG. 22, thereby disconnecting a conductive state formed between the contact pads (30N, 32N) in the main channel by the conductive fluid 50N. As a result, a non-conductive state is obtained between the contact pads (30N, 32N). On the other hand, when the driving device 60N is in a rest state, the driving fluid 70N moves from the main channel 10N toward the sub channel 20N, so that the conductive state between the contact pads (30N, 32N) is recovered by the conductive fluid 50N. Thus, the switching operation is achieved by use of the driving fluid 70N as the non-conductive fluid and the conductive fluid 50N. However, since it is needed to heat the driving fluid 70N, the switching response becomes a problem, as in the case described above. In addition, there is no guarantee that an inflow of the driving fluid 70N into the main channel 10N filled with the conductive fluid 50N is always repeated in the same manner. Therefore, variations in relay characteristics may occur.

### SUMMARY OF THE INVENTION

A primary concern of the present invention is to provide a relay device using a conductive fluid, which has advantages of excellent switching response, easiness of downsizing and stable relay characteristics, as compared with the conventional relay device using the heating means.

That is, the relay device of the present invention comprises:

a laminate having an interior space, and formed by bonding a semiconductor substrate to an insulating substrate;
at least two contacts exposed to the interior space;
a diaphragm portion formed on the semiconductor substrate to face the interior space;
a conductive fluid sealed in the interior space; and
an actuator configured to elastically deform the diaphragm portion;

wherein a volume change of the interior space resulting from an elastic deformation of the diaphragm portion causes a positional displacement of the conductive fluid in the interior space, thereby forming a conductive state or a non-conductive state between the contacts.

According to the present invention, since the positional displacement of the conductive fluid is obtained by the volume change of the interior space resulting from the elastic deformation of the diaphragm portion, an improvement in switching response can be achieved, as compared with the case of moving a liquid metal by use of thermal expansion of the air. In addition, since the diaphragm portion formed on the semiconductor substrate is deformed, the volume change of the interior space can be obtained with good response by use of a reduced driving force of the actuator, as compared with the case of elastically deforming a rigid material such as glass. Therefore, it is possible to provide a compact relay device with high switching response by use of an actuator having the capability of generating a relatively small driving force. The technical concept of the present invention can provide a normally open relay device where the conductive state between the contacts is kept in the rest state of the actuator, and the non-conductive state between the contacts is obtained in the active state of the actuator, as well as a normally close relay device where the non-conductive state between the contacts is kept in the rest state of the actuator, and the conductive state between the contacts is obtained in the active state of the actuator.

In the relay device described above, it is preferred that the semiconductor substrate is a Si substrate, and the diaphragm portion is integrally formed with the Si substrate. By using a semiconductor micromachining technique, the diaphragm portion can be easily formed on the Si substrate. It is effective to downsize the relay device.

In addition, it is preferred that one of opposite two surfaces of the semiconductor substrate is bonded to the insulating substrate, and the other surface has a concave portion, and wherein the diaphragm portion is formed at a bottom of the concave portion, and the actuator is accommodated in the concave portion. By placing the actuator in the concave portion, it becomes possible to further downsize the relay device.

In addition, it is preferred that one of the diaphragm portion and the actuator has a projection, and the diaphragm portion is connected to the actuator through the projection. The actuator can be accurately bonded at a position where the elastic deformation of the diaphragm portion is most effectively obtained, and therefore the relay device of high quality can be stably provided.

In addition, it is preferred that the insulating substrate has a stopper boss projecting in the interior space at a position facing the diaphragm portion. Alternatively, it is preferred that the diaphragm portion has a stopper boss projecting toward the interior space. By preventing that the diaphragm portion is excessively elastically deformed, it is effective for failure prevention and life lengthening of the relay device.

The actuator used in a preferred embodiment of the present invention is selected from a unimorph type piezoelectric actuator comprising a metal film formed on a surface of the diaphragm portion, and a piezoelectric film formed on the metal film, a bimorph type piezoelectric actuator comprising a first piezoelectric film formed on a surface of the diaphragm portion, a metal film formed on the first piezoelectric film, and a second piezoelectric film formed on the metal film, and a multilayer type piezoelectric actuator formed by alternately stacking a plurality of metal films and a plurality of piezoelectric films on a surface of the diaphragm portion.

In the relay device described above, it is also preferred that laminate has the interior space comprising a fluid storage portion which the diaphragm portion faces, and a fluid channel connected at its one end to the fluid storage portion, and closed at the other end, and wherein the at least two contacts are disposed in the fluid channel. In this case, since a sufficient moving distance of the conductive fluid in the fluid channel is obtained by the elastic deformation of the diaphragm portion, the switching operation can be efficiently achieved between contacts spaced from each other in the fluid channel by use of a small driving force of the actuator.

In addition, it is preferred that the fluid storage portion is configured in such a shape that its aperture area gradually decreases in a direction toward the fluid channel. The conductive fluid can be smoothly moved from the fluid storage portion into the fluid channel by the elastic deformation of the diaphragm portion. Specifically, when the diaphragm portion facing the fluid storage portion is configured in a substantially rectangular shape, and the fluid channel is coupled at a corner portion of the rectangular shape to the fluid storage portion, it becomes a preferred positional relation between the fluid storage portion and the fluid channel to obtain the above-described effect.

It is also preferred that the fluid channel has first and second regions with different wetting properties of the conductive fluid, and the second region is formed between adjacent contacts, and has a lower wetting property of the conductive fluid than the first region. In the relay device where the non-conductive state between the contacts is kept in the rest state of the actuator, and the conductive state between the contacts is obtained by allowing the conductive fluid to flow into the fluid channel in the active state of the actuator, when the activation of the actuator is stopped, most of the conductive fluid moves from the fluid channel toward the fluid storage portion. However, at this time, a part of the conductive fluid may remain in the fluid channel. When the conductive fluid remains between the contacts in the fluid channel, there is a fear that the conductive state between the contacts is maintained even in the rest state of the actuator, and consequently a desired relay operation cannot be stably obtained. In this regard, when the second region having the lower wetting property is formed between the contacts, the conductive fluid becomes hard to stay at the second region, as compared with the first region. Therefore, it is possible to prevent the inconvenience that the conductive fluid remains between the contacts from occurring. Thus, by forming a location (the second region) where the conductive fluid is hard to stably stay between the contacts in the fluid channel, it is possible to further improve the reliability of switching operation.

In the case of forming the second region, it is preferred that the second region has a larger surface roughness than the first region. Specifically, when a groove is formed as the fluid channel in the semiconductor substrate or the insulating substrate, the first and second regions with different surface roughnesses can be obtained by performing a blast treatment or an etching treatment to the groove surface.

Alternatively, it is preferred that the fluid channel has first and second regions with different cross-sectional areas or different cross-sectional shapes, and the second region is formed between adjacent contacts, and has a greater resistance to movement of said conductive fluid than the first region. This means that a location where the movement of the conductive fluid in the fluid channel is easily interrupted is formed on purpose between the contacts. Therefore, even when the conductive fluid remains between the contacts, the conductive fluid is decoupled by the second region. As a result, it is possible to reliably obtain the non-conductive state. Specifically, the second region can be designed to have an inner diameter smaller than the first region. Alternatively, the first and second regions may be formed to have a circular cross section and a triangular cross section, respectively. Thus, the second region having the greater resistance to movement of the conductive fluid can be obtained in the fluid channel.

In addition, it is preferred that the semiconductor substrate of the relay device of the present invention has the fluid channel formed such that the conductive fluid contacts a part of the contact disposed on the insulating substrate in the conductive state, and a shallow groove communicated with the fluid channel and formed around the contact to prevent the contact from contacting the semiconductor substrate. For example, the fluid channel having a small inner diameter can be formed in the semiconductor substrate by using the semiconductor micromachining technique. On the other hand, the contact needs to have a certain outer diameter to make the conductive state by contact with the conductive fluid. Thus, under the condition that the outer diameter of the contact is larger than the inner diameter of the fluid channel, when the semiconductor substrate (e.g., Si) is bonded to the insulating substrate (e.g., glass) by means of anodic bonding, there is a fear that a bonding failure or a discharge occurs at the time of the anodic bonding because the contact is caught between the Si substrate and the glass. Since the shallow groove formed in the semiconductor substrate prevents the contact from directly contacting the semiconductor substrate, it is possible to avoid the inconvenience described above. In this regard, the shallow groove is designed in such a depth that the conductive fluid does not flow into the shallow groove due to the surface tension. Therefore, there is no need to worry that the amount of the conductive fluid moving in the fluid channel is reduced by a leakage of the conductive fluid into the shallow groove, so that the switching operation becomes unstable.

In addition, it is preferred that the fluid channel is formed in a wave shape, which comprises straight channels extending in parallel to each other and a curved channel coupling between adjacent straight channels. In the case of forming plural pairs of contacts in the fluid channel, it is needed to extend the length of the fluid channel. On the other hand, the extension of the fluid channel may lead to an increase in size of the relay device. As described above, by forming the fluid channel with the wave shape, it is possible to extend the length of the fluid channel without increasing the size of the laminate, in which the fluid channel is formed. When using this fluid channel, it is particularly preferred that the contact is disposed at the vicinity of the curved channel.

In the relay device of the present invention, it is also preferred that the laminate has an injection channel configured to inject the conductive fluid into the fluid storage portion, and an inner surface of the injection channel has a metal film having a high wetting property of the conductive fluid. In this case, after the conductive fluid is injected into the fluid storage portion, the conductive fluid is easily held at the location having the metal film due to good wetting property of the conductive fluid on the metal film, which is formed on the inner surface of the injection channel. In addition, it is useful to prevent that a leakage of the conductive fluid occurs before the injection channel is sealed during the fabrication process of the relay device.

To smoothly switch between the conductive state between the contacts and the non-conductive state between the contacts, it is preferred that the conductive fluid is moved in the fluid channel, as described below. That is, in a rest state of the actuator, only one of the contacts always contacts the conductive fluid, and in an active state of the actuator, the conductive fluid moves into the fluid channel to form the conductive state between the contacts. In this case, since the moving distance of the conductive fluid in the fluid channel becomes short, it is possible to reduce the elastic deformation of the diaphragm portion, and therefore save the energy needed to operate the actuator. In addition, since a smooth mobility of the conductive fluid is obtained, as compared with the case where the conductive fluid passes through both of the contacts, a further improvement in switching reliability can be achieved. Alternatively, the same effects as the above can be achieved when in a rest state of the actuator, the conductive state between the contacts are kept by the conductive fluid, and in an active state of the actuator, the conductive fluid moves into the fluid channel to detach the conductive fluid from one of the contacts, thereby forming the non-conductive state between the contacts.

In the relay device of the present invention, it is preferred to form the fluid storage portion and the fluid channel, as described above. Alternatively, the contacts may be disposed in the fluid storage portion without forming the fluid channel. For example, the laminate comprises a fluid storage portion which the diaphragm portion faces, and the at least two contacts are disposed in the fluid storage portion, and wherein a positional displacement of the conductive fluid in the fluid storage portion is caused by the elastic deformation of the diaphragm portion, thereby forming the conductive state or the non-conductive state between the contacts. In this case, it is preferred that the diaphragm portion is configured in a substantially circular shape.

According to the basic concept of the relay device of the present invention, it is possible to provide a relay device, which has the capability of simultaneously performing plural operations of opening and closing between the contacts. For example, the laminate has the interior space comprising a fluid storage portion that the diaphragm portion faces, which is configured to accommodate the conductive fluid, a second fluid storage portion formed away from the fluid storage portion to accommodate the conductive fluid, and a fluid channel coupling between the fluid storage portion and the second fluid storage portion. A pair of contacts are located in the fluid channel within a predetermined range from the fluid storage portion, and another pair of contacts are located in the fluid channel within a predetermined range from the second fluid storage portion. In an active state of the actuator for elastically deforming the diaphragm portion, the relay device provides forming the conductive state between the pair of contacts by use of the conductive fluid provided from the fluid storage portion, and keeping the non-conductive state between the another pair of contacts. On the other hand, in a rest state of the actuator, the relay device provides forming the conductive state between the another pair of contacts by use of the conductive fluid provided from the second fluid storage portion, and keeping the non-conductive state between the pair of contacts.

Further characteristic and advantages of the present invention will be understand in more detail from the best mode for carrying out the invention, as described below.

### BRIEF EXPLANATION OF THE DRAWINGS

FIG. 1A is a top view of a relay device according to a first embodiment of the present invention, FIG. 1B is a schematic plan view showing a fluid storage portion and a fluid channel of the relay device, FIG. 1C is a cross-sectional view taken along the line X-X in FIG. 1B, and FIG. 1D is a cross-sectional view taken along the line Y-Y in FIG. 1B;

FIG. 2A is a schematic plan view showing a positional displacement of a conductive fluid in the fluid channel at the time of activating an actuator, FIG. 2B is a cross-sectional view taken along the line X-X in FIG. 2A, and FIG. 2C is a cross-sectional view taken along the line Y-Y in FIG. 2A;

FIG. 3A is a top view of a relay device according to a modification of the first embodiment, FIG. 3B is a schematic plan view showing a fluid storage portion and a fluid channel of the relay device, FIG. 3C is a cross-sectional view taken along the line X-X in FIG. 3B, and FIG. 3D is a cross-sectional view taken along the line Y-Y in FIG. 3B;

FIG. 4 is a cross-sectional view of a relay device, which has a projection on an actuator;

FIG. 5 is a cross-sectional view of a relay device, which has a stopper boss on a diaphragm portion;

FIG. 6 is a cross-sectional view of a relay device, which has a stopper boss on an insulating substrate;

FIG. 7 is a cross-sectional view of a relay device, which has a step in a concave for accommodating the actuator;

FIG. 8A is a schematic diagram of a low wetting-property region formed between contacts in a fluid channel, and FIG. 8B is a schematic diagram of a small diameter region formed between the contacts in the fluid channel;

FIG. 9A is a schematic plan view of a relay device having plural pairs of contacts in a fluid channel, and FIG. 9B is a cross-sectional view taken along the line Y-Y in FIG. 9A;

FIG. 10 is a schematic plan view of a relay device, which has a fluid channel formed in a wave-like pattern;

FIGS. 11A and 11B are respectively schematic view and cross-sectional view of a shallow groove formed around a contact;

FIGS. 12A and 12B are respectively schematic view and cross-sectional view of another shallow groove formed around the contact;

FIG. 13A is a schematic cross-sectional view of a relay device, which has a metal film formed in an injecting portion for conductive fluid, and FIG. 13B is a cross-sectional view of another injecting portion for conductive fluid;

FIG. 14A is a top view of a relay device according to a second embodiment of the present invention, FIG. 14B is a schematic plan view showing a fluid storage portion of the relay device, and FIG. 14C is a cross-sectional view taken along the line Z-Z in FIG. 14B;

FIG. 15A is a schematic diagram showing a positional displacement of a conductive fluid in the fluid storage portion at the time of activating an actuator, and FIG. 15B is a cross-sectional view taken along the line Z-Z in FIG. 15A;

FIG. 16A is a schematic plan view showing a fluid storage portion and a fluid channel of a relay device according to a third embodiment of the present invention, and FIG. 16B is a cross-sectional view taken along the line X-X in FIG. 16A;

FIG. 17A is a schematic plan view showing a positional displacement of a conductive fluid in the fluid storage portion at the time of activating an actuator, and FIG. 17B is a cross-sectional view taken along the line X-X in FIG. 17A;

FIGS. 18A and 18B are schematic diagrams showing an operation of a relay device according to a modification of the third embodiment;

FIGS. 19A and 19B are schematic diagrams showing a movement of a conductive fluid at the time of operating a relay device;

FIGS. 20A and 20B are schematic diagrams showing a movement of the conductive fluid at the time of operating another relay device;

FIG. 21 is a schematic diagram showing an operation of a conventional relay device using a conductive fluid; and

FIG. 22 is a schematic diagram showing an operation of another conventional relay device using the conductive fluid.

### BEST MODE FOR CARRYING OUT THE INVENTION

Referring to the attached drawings, a relay device of the present invention is explained in detail according to preferred embodiments.

### First Embodiment

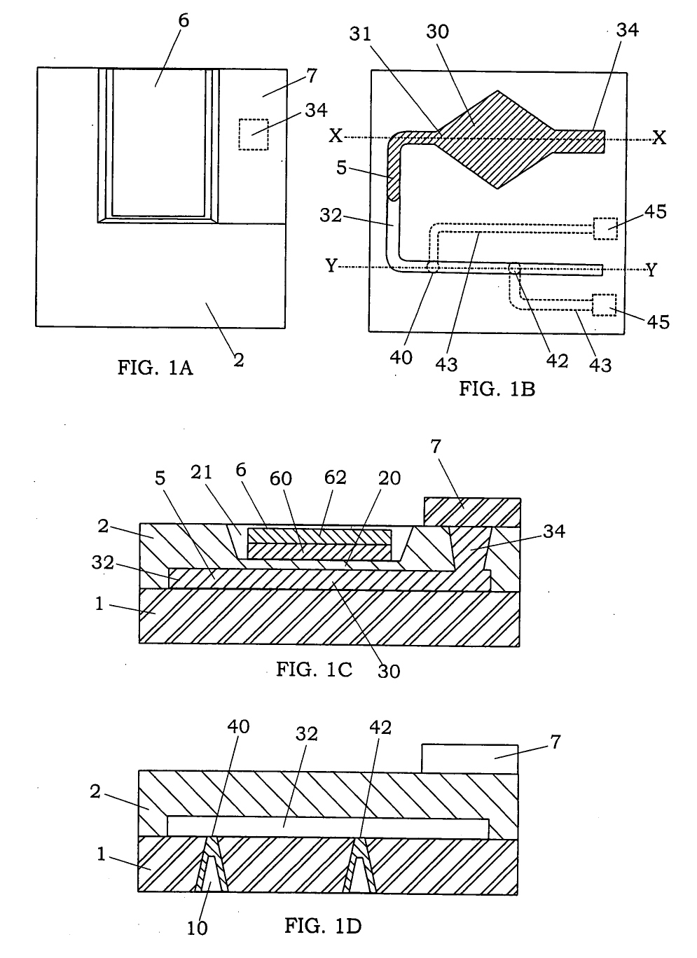

As shown in FIGS. 1A to 1D, a relay device of the first embodiment of the present invention is mainly provided with a laminate, which is formed by anodic bonding between an insulating substrate 1 and a semiconductor substrate 2 so as to have an interior space (fluid chamber) comprised of a fluid storage portion 30, in which a conductive fluid 5 is injected, and a fluid channel 32, a pair of contacts (40, 42) exposed to the fluid channel, a diaphragm portion 20 formed in the semiconductor substrate and facing the fluid storage portion 30, and an actuator 6 configured to elastically deform the diaphragm portion 20.

The insulating substrate 1 for the laminate is not limited, and a substrate having insulating property is available. For example, the insulating substrate 1 can be made of a glass material or an insulating resin material. In the present embodiment, a glass substrate is used as the insulating substrate 1. The insulating substrate 1 has a plurality of through holes 10 each configured in a substantially conical shape such that a tip of the conical shape reaches a top surface of the glass substrate. A plating layer of a conductive material (e.g., solder) is formed on an inner surface of the respective through hole 10. The tip of the conical shape of the through hole 10 is closed by the plating layer to provide the respective contact (40, 42). In the drawings, the reference numeral 45 designates a terminal formed on a bottom surface of the insulating substrate 1. The reference numeral 43 designates a wiring pattern for electrically connecting between each of the contacts (40, 42) and a corresponding terminal 45. In this regard, locations of forming the contacts (40, 42) are not limited to the insulating substrate 1 on the assumption that each of the contacts faces the interior space, and is accessible with the conductive fluid 5.

As the semiconductor substrate 2 for the laminate, for example, a Si single crystal substrate can be used. In the present embodiment, a semiconductor micromachining such as machining and etching is performed to a bottom surface of the semiconductor substrate 2, and then a top surface of the insulating substrate 1 is bonded to the bottom surface of the semiconductor substrate 2 to obtain the laminate having the fluid storage portion 30 and the fluid channel 32, as the interior space. In place of the semiconductor substrate 2, the top surface of the insulating substrate 1 may be mechanically processed. Alternatively, both of the insulating substrate and the semiconductor substrate may be processed before bonding the insulating substrate 1 to the semiconductor substrate 2 to obtain the laminate.

On the other hand, a concave 21 for accommodating the actuator 6 is formed in a top surface of the semiconductor substrate 2. In this case, a bottom portion of the concave functions as the diaphragm portion 20. The fluid channel 32 has an inner diameter smaller than the fluid storage portion 30, and configured in a substantially J-shape such that its one end is connected to the fluid storage portion 32, and the other end is closed. The shape of the fluid channel is not limited to a specific one. As described later, the fluid channel can be optionally designed according to the number of contact pairs disposed in the fluid channel. To simplify the explanation, the single pair of contacts (40, 42) are disposed in the fluid channel 32 to be spaced from each other by a predetermined distance. In addition, a non-conductive fluid such as nitrogen or inert gas other than the air may be filled in a space of the fluid channel, in which the conductive fluid 5 does not exist.

The fluid storage portion 30 is formed in a substantially rhombus shape in its plan view. As the conductive fluid 5 injected in the fluid storage portion 30, a conductive fluid such as mercury is available, which is in a liquid state at room temperature and pressure. As shown in FIG. 1B, the fluid channel 32 is coupled to a corner portion 31 of the substantially rhombus shape. Thus, since the coupling portion between the fluid storage portion 30 and the fluid channel 32 is formed such that the aperture area gradually decreases toward the fluid channel, the conductive fluid can smoothly move from the fluid storage portion 30 into the fluid channel 32. In addition, a moving distance of the conductive fluid 5 in the active state of the actuator 6 can be easily controlled, and air bubbles become hard to remain in the fluid storage portion 30 accommodating the conductive fluid 5. In the drawings, the reference numeral 34 designates an injection hole used to inject the conductive fluid 5 into the fluid storage portion 30. The injection hole is formed at a corner portion of the fluid storage portion, which is located at the opposite side of the corner portion connected to the fluid channel 32. After the conductive fluid 5 is injected, the injection hole 34 is closed by a cover 7, and the interior space is sealed.

The diaphragm portion 20 provides a ceiling surface for the fluid storage portion 30, in which the conductive fluid 5 is injected. It is preferred that the diaphragm portion 20 is integrally formed with the Si substrate by use of a semiconductor micromachining technique, e.g., anisotropic etching. As the actuator 6 for elastically deforming the diaphragm portion 20, a unimorph-type piezoelectric actuator can be used, which is formed with a metal film 60 formed on a top surface of the diaphragm portion 20, and a piezoelectric film 62 formed on the metal film. When a larger driving force is needed, a bimorph-type piezoelectric actuator or a multilayer-type piezoelectric actuator may be used. The bimorph-type piezoelectric actuator is formed with a first piezoelectric film formed on a surface of the diaphragm portion, a metal film formed on the first piezoelectric film and a second piezoelectric film formed on the metal film. The multilayer-type piezoelectric actuator is formed by alternately stacking a plurality of metal films and a plurality of piezoelectric films on a surface of the diaphragm portion. By applying a predetermined voltage, a bending of the actuator 6 occurs in the thickness direction to elastically deform the diaphragm portion 20.

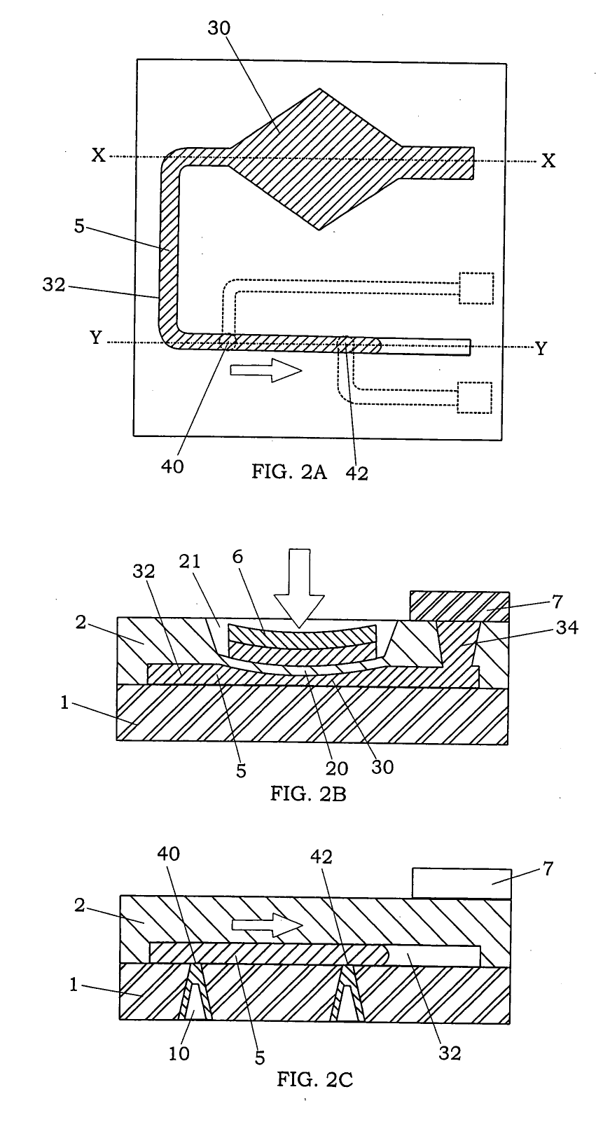

In the relay device described above, an injection amount of the conductive fluid 5 in the fluid storage portion 30 is determined such that the conductive fluid 5 does not exist between the contacts (40, 42) in the fluid channel 32 when the actuator 6 is in a rest state. Next, when the actuator 6 is operated, the elastic deformation of the diaphragm portion 20 is caused by the driving force of the actuator 6 to reduce the volume of the fluid storage portion 30, as shown in FIGS. 2A to 2C, so that the conductive fluid 5 is pushed out into the fluid channel 32 in a direction shown by an arrow in FIG. 2A. The conductive fluid pushed out into the fluid channel 32 forms a conductive state between the contacts (40, 42). Then, when the activation of the actuator 6 is stopped, the original volume of the fluid storage portion 30 is recovered, so that the conductive fluid 5 pushed out into the fluid channel 32 moves back toward the fluid storage portion 30. As a result, a non-conductive state is obtained between the contacts (40, 42). Thus, the relay device of the present embodiment is a normally-open type relay where the non-conductive state between the contacts (40, 42) are maintained unless the actuator 6 is activated. Alternatively, the relay device of the present embodiment may be provided as a normally-close type relay. In this case, the injection amount of the conductive fluid 5 in the fluid storage portion 30 is determined such that the conductive fluid 5 exists between the contacts (40, 42) in the fluid channel 32 when the actuator 6 is in the rest state. When the actuator 6 is activated, the diaphragm portion 20 is elastically deformed such that the conductive fluid 5 in the fluid channel 32 is sucked in the fluid storage portion 30. As a result, the non-conductive state between the contacts can be obtained by the movement of the conductive fluid 5.

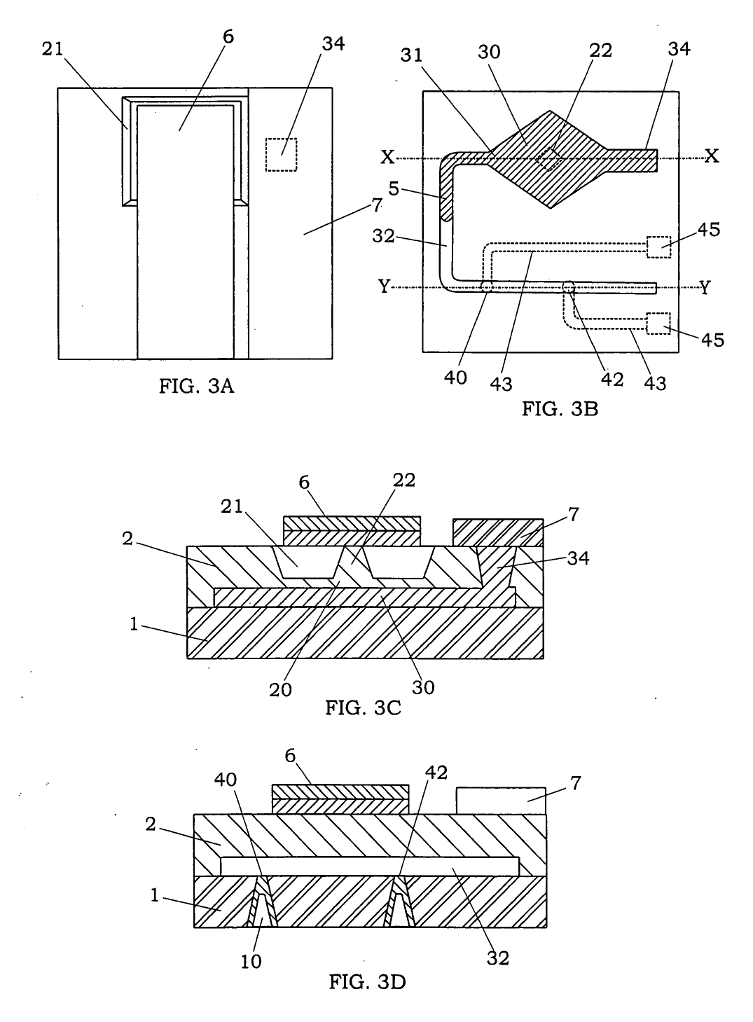

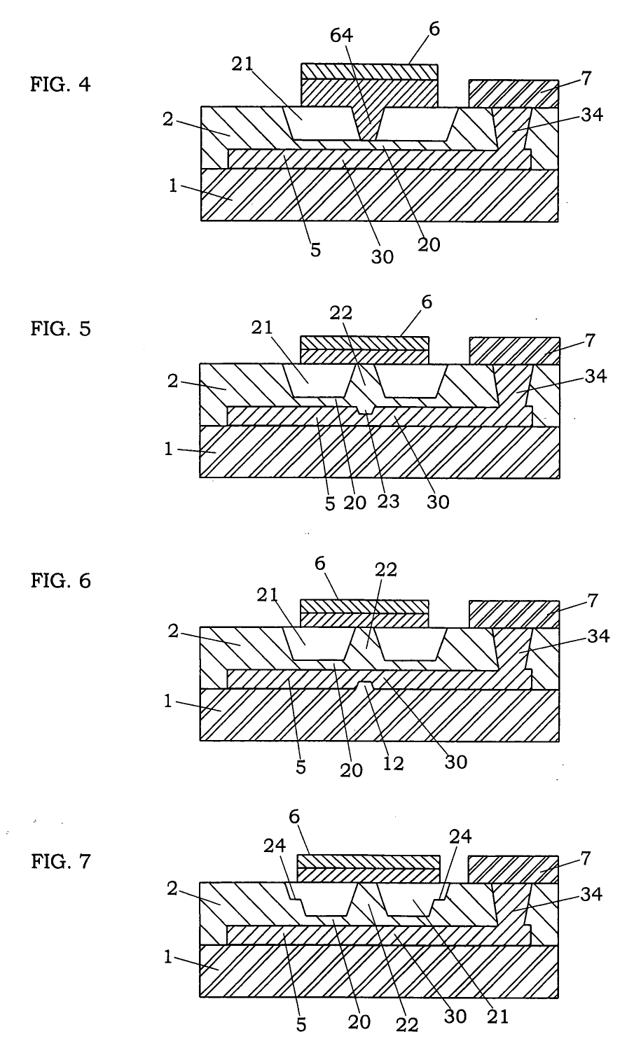

To efficiently cause the elastic deformation of the diaphragm portion 20 by the actuator 6, it is preferred that a projection 22 is integrally formed with the diaphragm portion, and located at a substantially center portion of the diaphragm portion 20 (configured in the rhombus shape), as shown in FIGS. 3A to 3D. In this case, the diaphragm portion 20 is connected to the actuator 6 through this projection 22, so that the driving force of the actuator 6 can be efficiently transmitted to the diaphragm portion 20 through the projection 22. Alternatively, as shown in FIG. 4, the actuator 6 may be connected to the diaphragm portion 20 through a projection 64 formed on the actuator 6 to obtain the same effect as the above. In this relay device, one end of the actuator 6 is bonded to a top surface of the semiconductor substrate 2 in a cantilever fashion that the other end of the actuator projects above the concave 21, as shown in FIG. 3A. If necessary, both ends of the actuator 6 may be bonded to the semiconductor substrate 2 to have a double supported beam structure where the actuator 6 straddles the concave 21. In addition, the shape of the projection (22, 64) is not limited to a specific one. From the viewpoint of preventing stress concentration, it is preferred that the projection is configured in a columnar shape or a conical trapezoid shape. When the projection is configured in a truncated pyramid shape, chamfering is preferably performed to the edge portions.

To prevent that the elastic deformation of the diaphragm portion 20 is excessively caused, it is also preferred that a stopper boss 23 is formed on a surface of the diaphragm portion 20 facing the fluid storage portion 30, as shown in FIG. 5. A height of the stopper boss 23 is determined such that the stopper boss contacts the insulating substrate 1 when the diaphragm portion 20 is excessively deformed. Thereby, it is possible to prevent a breakage of the diaphragm portion 20 from occurring. In place of the formation of the stopper boss 23 on the diaphragm portion 20, a stopper boss 12 may be formed on a surface of the insulating substrate 1 facing the diaphragm portion 20 to obtain the same effect as the above, as shown in FIG. 6.

In addition, as shown in FIG. 7, it is preferred that a step portion 24 is formed in the concave 21 such that the actuator 6 comes into contact with the step portion when the elastic deformation of the diaphragm portion 20 is excessively caused. It is possible to control the elastic deformation amount of the diaphragm portion 20 caused by the actuator 6, and obtain the same effect as the stopper boss (23, 12).

By the way, in the case of a compact relay device where an inner diameter of the fluid channel 32 is relatively small (e.g., 1 mm or less), there is a fear that a stable relay operation is not obtained due to variations in moving distance of the conductive fluid 5 in the fluid channel 32. For example, under a condition that the conductive fluid 5 is pushed out into the fluid channel 32 by the elastic deformation of the diaphragm portion 20, when the activation of the actuator 6 is stopped, most of the conductive fluid 6 moves back toward the fluid storage portion 30 by help of an air pressure in the fluid channel 32. However, a part of the conductive fluid may often remain in the fluid channel 32. In this case, when the conductive fluid remains between the contacts (40, 42), the non-conductive state between the contacts cannot be obtained despite the rest state of the actuator 6.

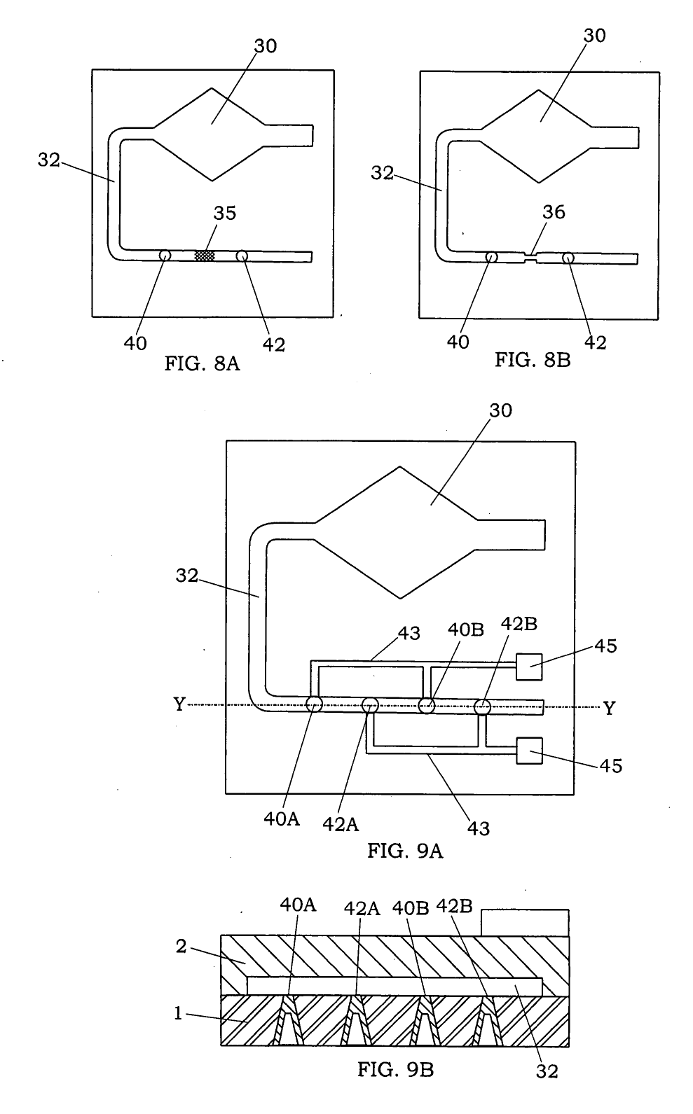

To obtain a stable relay operation even when the fluid channel 32 has such a small inner diameter, it is preferred to take a measure such that the conductive fluid 5 remaining in the fluid channel 32 becomes hard to stably stay between the contacts (40, 42). For example, as shown in FIG. 8A, a region 35 having a low wetting property of the conductive fluid can be formed on an inner surface of the fluid channel 32 and between the contacts (40, 42). In this case, even when the conductive fluid remains between the contacts (40, 42), it is easy to move toward another region having higher wetting property because the contact resistance of the conductive fluid is low at the region 35 having the low wetting property. Thus, the conductive fluid becomes hard to stay between the contacts in the rest state of the actuator, and consequently the non-conductive state between the contacts can be obtained with reliability. In this regard, since the interior space of the fluid channel 32 between the contacts is filled with the conductive fluid 5 when the actuator 6 is activated, the presence of the region 35 having the low wetting property between the contacts does not disturb the formation of the conductive state therebetween. To form the region 35 having the low wetting property, for example, a blast treatment or an etching treatment can be performed to a groove formed as the fluid channel 32 in the semiconductor substrate 2. Alternatively, a fluorocarbon resin film may be formed as a surface roughing treatment.

In addition, a region having an increased resistance to movement of the conductive fluid 5 may be formed between the contacts (40, 42) in the fluid channel 32. For example, as shown in FIG. 8B, it is preferred to form a region 36 having an inner diameter locally narrowed between the contacts (40, 42) in the fluid channel 32, or change the cross sectional shape of the fluid channel between the contacts (e.g., a region having a triangular cross section can be locally formed in the fluid channel 32 having a circular cross section). In these cases, the flow of the conductive fluid 5 can be easily interrupted between the contacts. Thus, when a location where the flow of the conductive fluid is easily interrupted is formed on purpose between the contacts, it is possible to reliably obtain the non-conductive state between the contacts (40, 42) even when a part of the conductive fluid remains between the contacts in the rest state of the actuator.

In the case of opening and closing between the contacts by the movement of the conductive fluid 5 in the fluid channel 32, ideally speaking, it is enough to form one pair of the contacts (40, 42) in the fluid channel 32. However, in fact, variations in moving distance of the conductive fluid 5 in the fluid channel 32 occur due to various kinds of factors such as the driving force of the actuator, the elastic deformation amount of the diaphragm portion, the volume of the interior space of the laminate and the amount of the conductive fluid injected in the fluid storage portion. Therefore, from the viewpoint of achieving an improvement in reliability of the relay device, it is preferred that the relay device has the flexibility to cope with the occurrence of the variations.

To reduce the influence of the above-described variations on the operation reliability of the relay device, it is preferred that a pair of contacts are formed at every predetermined distance in the fluid channel 32, and one contact pair of the plural contact pairs is used to form the conductive state. Specifically, as shown in FIGS. 9A and 9B, a pair of first contacts (40A, 42A) and a pair of second contacts (40B, 42B) are formed in the fluid channel 32. One of the first contacts (40A) and one of the second contacts (40B) are electrically connected to a corresponding terminal 45 through a wiring pattern 43 on a bottom surface of the insulating substrate 1. Similarly, the other one of the first contacts (42A) and the other one of the second contacts (42B) are electrically connected to a corresponding terminal 45 through a wiring patter 43 on the bottom surface of the insulating substrate 1. By forming the plural contact pairs in the fluid channel 32, when the moving distance of the conductive fluid 5 in the active state of the actuator 6 is relatively short, the first contact pair (40A, 42A) is used to switch between the conductive state and the non-conductive state. On the other hand, when the moving distance of the conductive fluid 5 in the active state of the actuator 6 is relatively long, the second contact pair (40B, 42B) is used to switch between the conductive state and the non-conductive state. Thus, this relay device has the flexibility to cope with the variations in positional displacement (moving distance) of the conductive fluid 5. In this regard, the electrical connection between the useless contacts and the terminals may be cut off, if necessary.

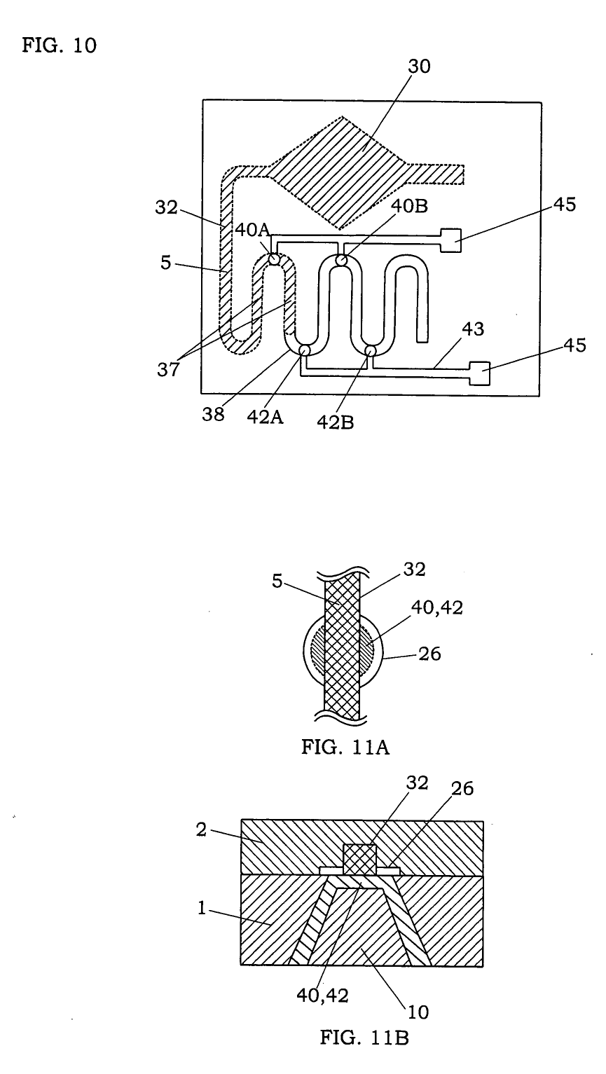

As described above, when forming the plural contact pairs in the fluid channel 32, it is needed to extend the length of the fluid channel 32 depending on the number of the contacts to be formed. However, the increase in length of the fluid channel 32 may lead to an increase in size of the relay device as a whole. Therefore, as shown in FIG. 10, it is preferred that the fluid channel 32 is configured in a wave shape. This fluid channel 32 is formed with straight channels 37 extending in substantially parallel to each other and a curved channel 38 coupling between adjacent straight channels 38. Each of the contacts can be disposed at the vicinity of the curved channel 38. The shape of the fluid channel 32 is not limited to the wave shape. Another shape of the fluid channel 32 is also available on the assumption that the fluid channel having a desired length can be formed in a certain area.

By the way, the fluid channel 32 having the small inner diameter (e.g., 1 mm or less) can be formed by use of the semiconductor micromachining technique. However, there is a case that the contact formed on the insulating substrate 1 must have a certain size to ensure the reliability of electrical connection. For example, under the condition that the inner diameter of the fluid channel 32 is smaller than the size of the contact, when the insulating substrate 1 having the contacts (40, 42) is bonded to the semiconductor substrate 2 having a groove as the fluid channel 32 by anodic bonding to form the laminate, there is a fear that the reliability of the electrical connection deteriorates due to the adherence of the semiconductor material (Si) to the contact surface. Therefore, when forming such a fine fluid channel 32, it is preferred form a shallow groove 26 communicated with the fluid channel 32 at the circumference of the respective contact (40, 42), as shown in FIGS. 11A and 11B. The shallow groove 26 is formed such that the contacts (40, 42) do not directly contact the semiconductor substrate 2 when the insulating substrate 1 is bonded to the semiconductor substrate 2. In addition, a depth of the shallow groove 26 is determined such that the conductive fluid 5 flowing in the fluid channel 32 does not leak into the shallow groove due to its surface tension. Thereby, even when downsizing the relay device, it is possible to ensure the reliability of the electrical connection.

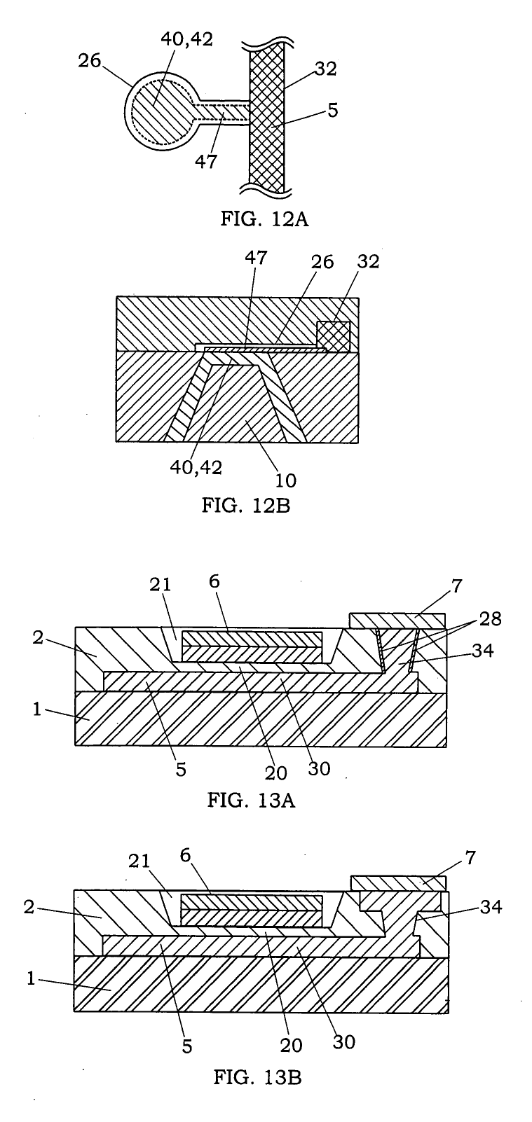

In addition, as shown in FIGS. 12A and 12B, it is preferred that each of the contacts (40, 42) is formed at a position away from the fluid channel 32, and a lead portion 47 is formed to extend between the fluid channel 32 and the contact. In this case, the shallow groove 26 is formed in such a shape that the semiconductor substrate 2 does not directly contact the contacts (40, 42) and the lead portion 47.

As shown in FIG. 13A, it is also preferred that a metal film 28 with high wetting property of the conductive fluid 5 is formed on an inner surface of an injection hole 34 used to inject the conductive fluid 5 into the fluid storage portion 30. As a material of the metal film 28, when the semiconductor substrate is made of Si, chromium or titanium is available. Thereby, the conductive fluid 5 becomes hard to leak from the fluid storage portion 30 until the injection hole 34 is closed by the cover 7. In addition, as shown in FIG. 13B, when the injection hole 34 is formed to have a wide opening, the operation of injecting the conducting fluid 5 becomes easy. Moreover, the conductive fluid 5 becomes hard to contact the cover 7 after the injection hole 34 is closed by the cover 7.

### Second Embodiment

A relay device of the present embodiment is characterized in that a fluid storage portion has a substantially circular shape in its plan view, and a pair of contacts are disposed in the fluid storage portion without the formation of a fluid channel. That is, this relay device is substantially the same as the relay device of the first embodiment except for the following features. Therefore, the duplicate explanation of common parts will be omitted.

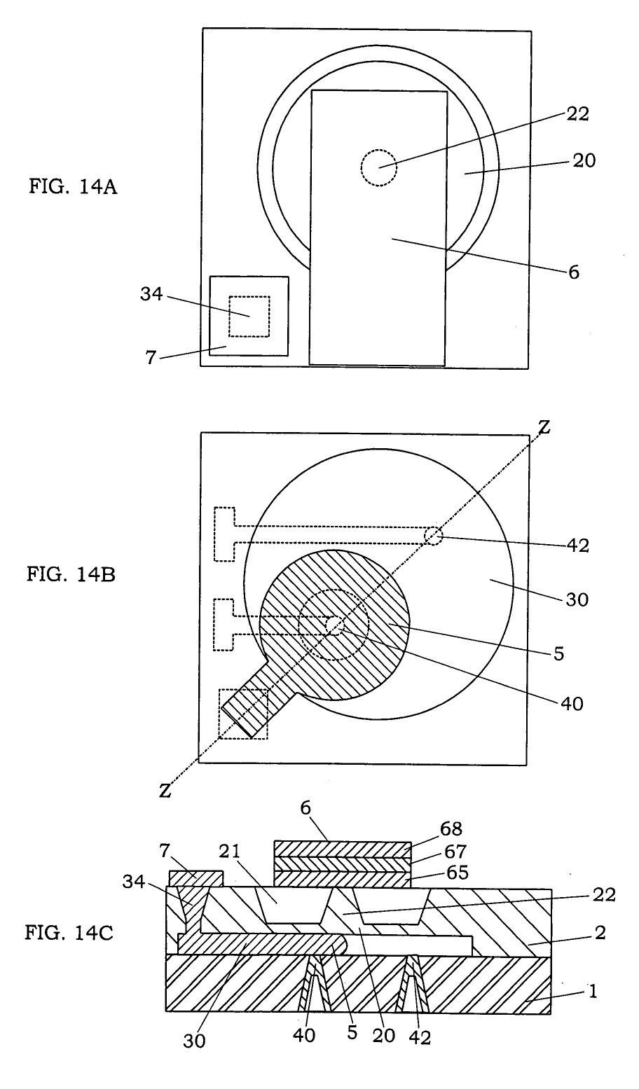

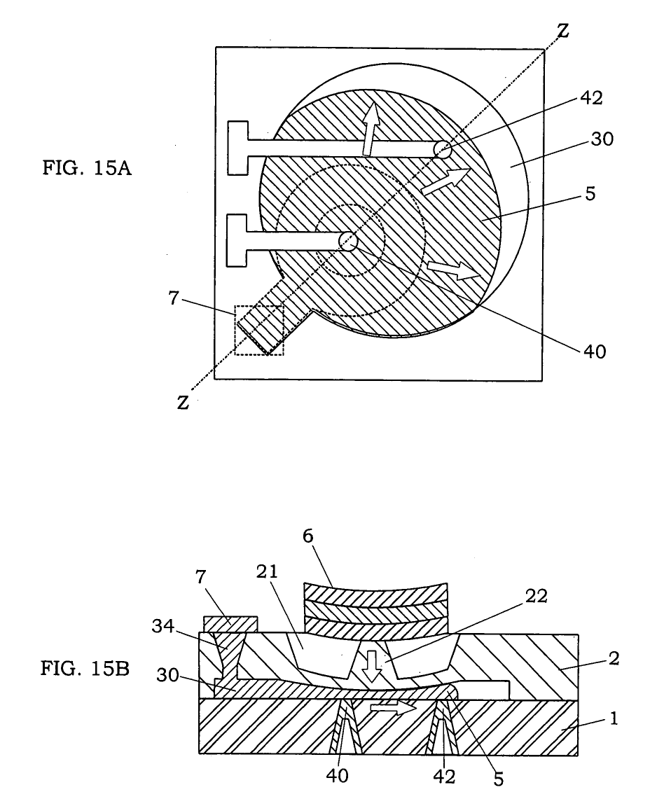

In the relay device of the present embodiment, as shown in FIGS. 14A to 14C, the fluid storage portion 30 has a substantially circular shape in its plan view, and the pair of the contacts (40, 42) are formed on the insulating substrate 1 to be exposed to the fluid storage portion 30. The conductive fluid 5 is injected in the fluid storage portion 30 to always contact only one of the contacts (40) in the rest state of the actuator 6. When the actuator is activated under this condition, the circular diaphragm portion 20 is elastically deformed, so that the conductive fluid moves toward the other contact 42 in the fluid storage portion, as shown by arrows in FIGS. 15A and 15B. Thereby, a conductive state between the contacts (40, 42) is formed in the fluid storage portion 30.

The actuator 6 used in the present embodiment is a bimorph type piezoelectric actuator including a first piezoelectric film 65 formed on a surface of the diaphragm portion 20, a metal film 67 formed on the first piezoelectric film 65, and a second piezoelectric film 68 formed on the metal film. In addition, a projection 22 is formed at a substantially center of the circular diaphragm portion 20, and the actuator 6 is connected to the diaphragm portion through the projection 22. The position of the projection 22 is not limited to the substantially center of the diaphragm portion 20. Alternatively, the projection 22 may be formed at a position where the conductive fluid is allowed to efficiently move toward the other contact by the elastic deformation of the diaphragm portion 20.

### Third Embodiment

According to the basic concept of the first embodiment, a relay device of the present embodiment is characterized by simultaneously controlling a pair of contacts configured in a normally-open state and a pair of contacts configured in a normally-close state by operation of an actuator. That is, this relay device is substantially the same as the relay device of the first embodiment except for the following features. Therefore, the duplicate explanation of common parts will be omitted.

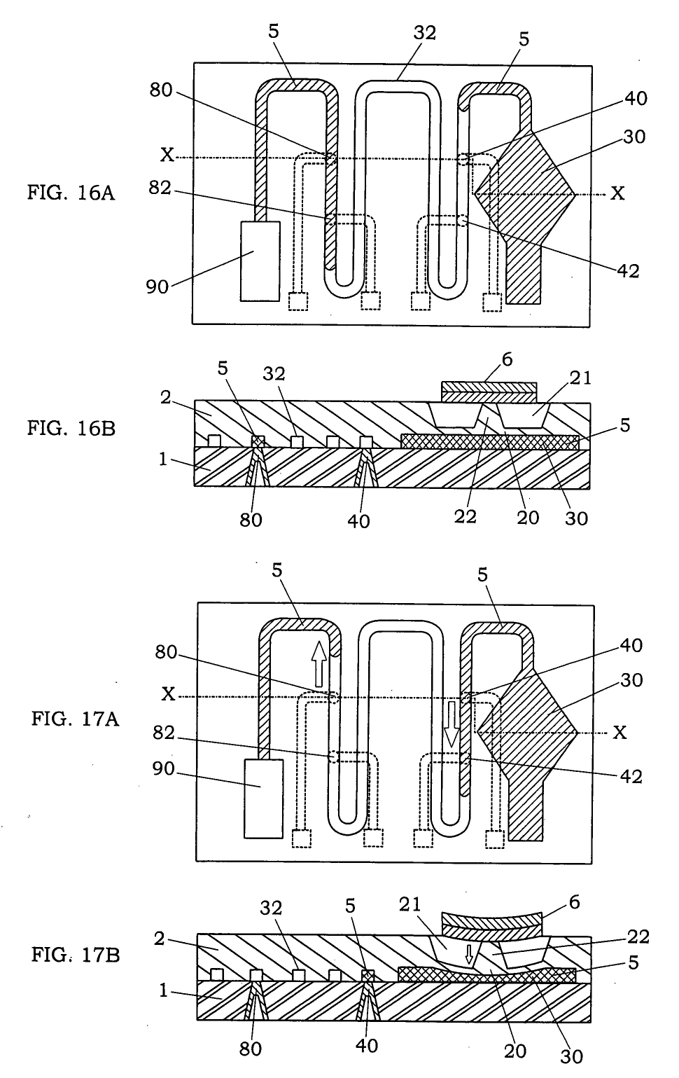

As shown in FIGS. 16A and 16B, the relay device of the present embodiment has an interior space, which is comprised of a fluid storage portion 30 that the diaphragm portion 20 faces, which is configured to accommodate a conductive fluid 5 therein, a second fluid storage portion 90 formed way from the fluid storage portion 30 to accommodate the conductive fluid 5 therein, and a fluid channel 32 coupling between the fluid storage portion 30 and the second fluid storage portion 90. A pair of contacts (40, 42) are disposed at positions spaced from the fluid storage portion 30 by predetermined distances in the fluid channel 32, as in the first embodiment. On the other hand, another pair of contacts (80, 82) are disposed at positions spaced from the second fluid storage portion 90 by predetermined distances in the fluid channel 32. When the actuator 6 is not activated, a conductive state between the contacts (80, 82) is formed by the conductive fluid 5 provided from the second fluid storage portion 90, and a non-conductive state between the contacts (40, 42) is kept, as shown in FIG. 16A.

Under this condition, when the actuator 6 is activated, the conductive fluid 5 in the fluid storage portion 30 is pushed out into the fluid channel 32 by an elastic deformation of the diaphragm portion 20, so that the conductive state between the contacts (40, 42) is formed, as shown in FIGS. 17A and 17B. On the other hand, the conductive fluid 5 used to form the conductive state between the contacts (80, 82) in the rest state of the actuator 6 is moved toward the second fluid storage portion 90 by an air pressure in the fluid channel 32, so that the non-conductive state between the contacts (80, 82) is formed.

Under this condition, when the activation of the actuator 6 is stopped, the conductive fluid 5 used to form the conductive state between the contacts (40, 42) moves back toward the fluid storage portion 30, so that the non-conductive state between the contacts (40, 42) is obtained again. On the other hand, since the interior of the fluid channel 32 becomes a reduced atmosphere by the movement of the conductive fluid 5 into the fluid storage portion 30, the conductive fluid 5 is sucked from the second fluid storage portion 90 into the fluid channel 32, so that the conductive state between the contacts (80, 82) is formed again. Thus, the operations of opening and closing between the contacts (40, 42) and between the contacts (80, 82) can be controlled by use of a single actuator 6. In this regard, when one of the contacts (40, 42) that are normally open contacts is short-circuited with one of the contacts (80, 82) that are normally close contacts, it can be used as a transfer contact.

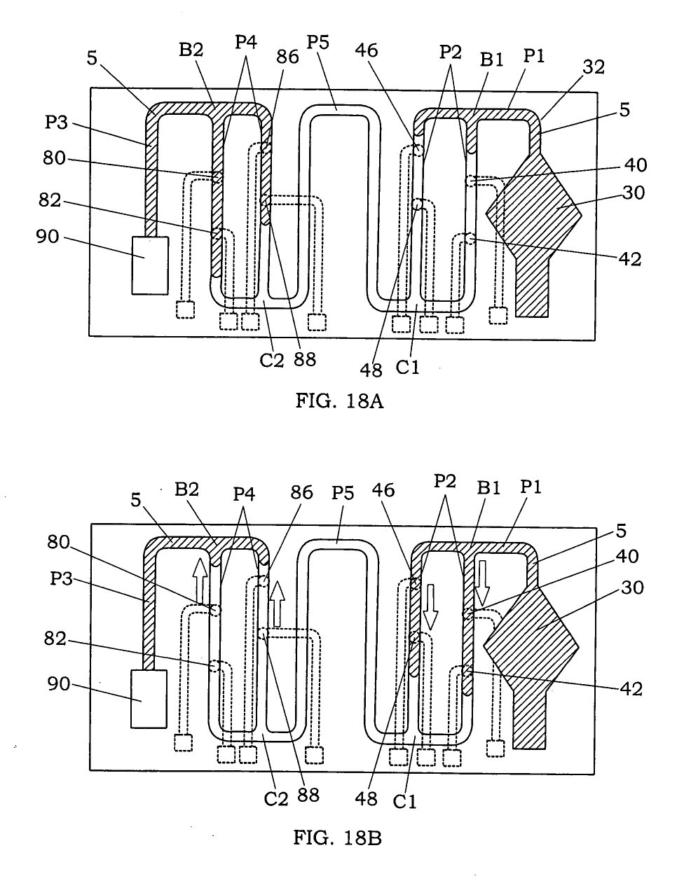

A modification of the present embodiment is shown in FIGS. 18A and 18B. This modification is different from the present embodiment by allowing the fluid channel to have branch channels, and simultaneously controlling the operations of opening and closing four pairs of contacts by operation of a single actuator. However, the operation mechanism is basically the same.

That is, the fluid channel 32 of this modification is formed with a first flow channel P1 connected at its one end to the fluid storage portion 30 and at the other end to a branch portion B1, a pair of first parallel channels P2 formed between the branch portion B1 and a merge portion C1, a second flow channel P3 connected at its one end to the second fluid storage portion 90 and at the other end to a branch portion B2, a pair of second parallel channels P4 formed between the branch portion B2 and a merge portion C2, and a junction channel P5 extending between the merge portions (C1, C2). In each of the first parallel channels P2, a pair of contacts ((40, 42), (46, 48)) are disposed, as in the first embodiment. Similarly, a pair of contacts ((80, 82), (86, 88)) are disposed in each of the second parallel channels P4. As shown in FIG. 18A, when the actuator 6 is not activated, non-conductive states between the contacts (40, 42) and between the contacts (46, 48) are kept in the first parallel channels P2, and conductive states between the contacts (80, 82) and between the contacts (86, 88) are formed in the second parallel channels P4 by the conductive fluid 5 provided from the second fluid storage portion 90.

Under this condition, when the actuator 6 is activated, the conductive fluid 5 is pushed out the fluid storage portion 30 into the fluid channel 32 by an elastic deformation of the diaphragm portion 20, so that the conductive states between the contacts (40, 42) and between the contacts (46, 48) are formed in the first parallel channels P2, as shown in FIG. 18B. On the other hand, the conductive fluid 5 used to form the conductive states between the contacts (80, 82) and between the contacts (86, 88) in the second parallel channels P4 in the rest state of the actuator 6 is moved toward the second fluid storage portion 90 by an air pressure in the junction channel P5, so that the non-conductive states between the contacts (80, 82) and between the contacts (86, 88) are obtained in the second parallel channels P4. Thus, the operation of opening and closing the four pairs of contacts can be controlled by use of the single actuator.

In the present embodiment, it was explained about the case where the operation of opening and closing the two pairs of contacts or the four pairs of contacts is controlled by use of the single actuator. However, the number of the contact pairs to be controlled is not limited to them, and can be optionally determined by appropriately designing the fluid channel.

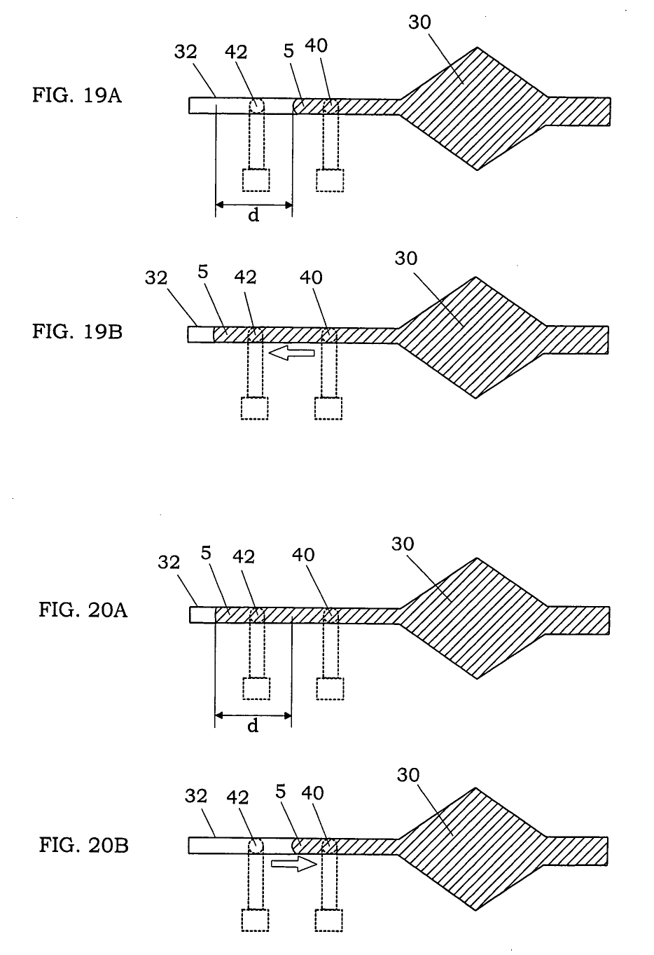

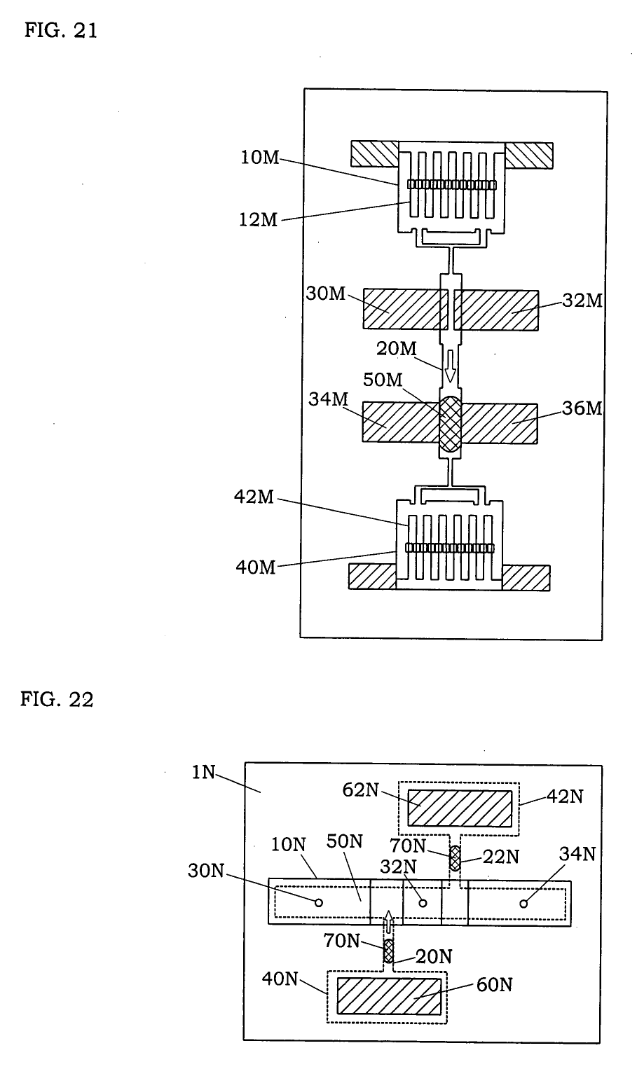

In the relay device of the first embodiment shown in FIGS. 1A and 2A, it was explained about the case where the conductive fluid 5 does not contact both of the contacts (40, 42) in the rest state of the actuator 6, and the conductive fluid 5 comes into contact with both of the contacts in the active state of the actuator 6. Alternatively, as shown in FIGS. 19A and 19B, the conductive fluid 5 may always contact one (40) of the contacts in the rest state (FIG. 19A) of the actuator 6. When the actuator is activated, the conductive fluid 5 moves in a direction away from the fluid storage portion 30 in the fluid channel 32 to form the conductive state between the contacts (40, 42), as shown in FIG. 19B. In this case, the conductive fluid 5 is needed to pass through only one of the contacts in the active state of the actuator. Therefore, a wetting force (friction resistance) between the contact and the conductive fluid can be reduced in half, as compared with the case where the conductive fluid pass through both of the contacts (40, 42). As a result, it is possible to obtain a smooth movement of the conductive fluid in the fluid channel. This modification is equally applicable to the relay device of the third embodiment shown in FIGS. 16A and 17A, and the relay device shown in FIGS. 18A and 18B.

In addition, as shown in FIGS. 20A and 20B, the conductive fluid 5 may always contact both of the contacts (40, 42) in the fluid channel 32 in the rest state (FIG. 20A) of the actuator 6. When the actuator is activated, the conductive fluid moves toward the fluid storage portion 30 in the fluid channel 32 to form the non-conductive state between the contacts, as shown in FIG. 20B. In this case, the same advantage described above can be obtained. In FIGS. 19A and 20A, the reference letter “d” designates a moving distance of the conductive fluid 5.

### INDUSTRIAL APPLICABILITY

As understood from the above embodiments, the relay device using the conductive fluid of the present invention has excellent response because the conductive fluid is moved by the elastic deformation of the diaphragm portion to perform the switching operation between the contacts, as compared with the conventional case where the conductive fluid is moved by heating to perform the switching operation between the contacts. In addition, since the diaphragm portion is formed on the semiconductor substrate such as Si, it is possible to reduce the driving force of the actuator needed to elastically deform the diaphragm portion. Furthermore, when a region with a low wetting property of the conductive fluid is formed in an inner surface of the fluid channel that the conductive fluid contacts, the operation of opening and closing between the contacts can be reliably obtained by a movement of the conductive fluid in the fluid channel. Thus, the relay device of the present invention is expected to be especially utilized in applications requiring high switching response and downsizing.

1. A relay device comprising:
a laminate having an interior space, and formed by bonding a semiconductor substrate to an insulating substrate;
at least two contacts exposed to said interior space;
a diaphragm portion formed on said semiconductor substrate to face said interior space;
a conductive fluid sealed in said interior space; and
an actuator configured to elastically deform said diaphragm portion;
wherein a volume change of said interior space resulting from an elastic deformation of said diaphragm portion causes a positional displacement of said conductive fluid in said interior space, thereby forming a conductive state or a non-conductive state between said contacts.

2. The relay device as set forth in claim 1, wherein said semiconductor substrate is a Si substrate, and said diaphragm portion is integrally formed with said Si substrate.

3. The relay device as set forth in claim 1, wherein one of opposite two surfaces of said semiconductor substrate is bonded to said insulating substrate, and the other surface has a concave portion, and wherein said diaphragm portion is formed at a bottom of said concave portion, and said actuator is accommodated in said concave portion.

4. The relay device as set forth in claim 1, wherein one of said diaphragm portion and said actuator has a projection, and said diaphragm portion is connected to said actuator through said projection.

5. The relay device as set forth in claim 1, wherein said insulating substrate has a stopper boss projecting in said interior space at a position facing said diaphragm portion.

6. The relay device as set forth in claim 1, wherein said diaphragm portion has a stopper boss projecting toward said interior space.

7. The relay device as set forth in claim 1, wherein said actuator is selected from a unimorph type piezoelectric actuator comprising a metal film formed on a surface of said diaphragm portion, and a piezoelectric film formed on said metal film,
a bimorph type piezoelectric actuator comprising a first piezoelectric film formed on a surface of said diaphragm portion, a metal film formed on said first piezoelectric film, and a second piezoelectric film formed on said metal film, and
a multilayer type piezoelectric actuator formed by alternately stacking a plurality of metal films and a plurality of piezoelectric films on a surface of said diaphragm portion.

8. The relay device as set forth in claim 1, wherein said laminate has said interior space comprising a fluid storage portion which said diaphragm portion faces, and a fluid channel connected at its one end to said fluid storage portion, and closed at the other end, and wherein said at least two contacts are disposed in said fluid channel.

9. The relay device as set forth in claim 8, wherein said fluid storage portion is configured in such a shape that its aperture area gradually decreases in a direction toward said fluid channel.

10. The relay device as set forth in claim 9, wherein said diaphragm portion facing said fluid storage portion is configured in a substantially rectangular shape, and said fluid channel is coupled at a corner portion of said rectangular shape to said fluid storage portion.

11. The relay device as set forth in claim 8, wherein said fluid channel has first and second regions with different wetting properties of said conductive fluid, and said second region is formed between adjacent contacts, and has a lower wetting property of said conductive fluid than said first region.

12. The relay device as set forth in claim 11, wherein said second region has a larger surface roughness than said first region.

13. The relay device as set forth in claim 8, wherein said fluid channel has first and second regions with different cross-sectional areas or different cross-sectional shapes, and said second region is formed between adjacent contacts, and has a greater resistance to movement of said conductive fluid than said first region.

14. The relay device as set forth in claim 13, wherein an inner diameter of said second region is smaller than that of said first region.

15. The relay device as set forth in claim 8, wherein said semiconductor substrate has said fluid channel formed such that said conductive fluid contacts a part of said contact disposed on said insulating substrate in the conductive state, and a shallow groove communicated with said fluid channel and formed around said contact to prevent said contact from contacting said semiconductor substrate.

16. The relay device as set forth in claim 8, wherein said fluid channel is formed in a wave shape, which comprises straight channels extending in parallel to each other and a curved channel coupling between adjacent straight channels.

17. The relay device as set forth in claim 16, wherein each of said contacts is disposed at the vicinity of said curved channel.

18. The relay device as set forth in claim 8, wherein said laminate has an injection channel configured to inject said conductive fluid into said fluid storage portion, and an inner surface of said injection channel has a metal film having a high wetting property of said conductive fluid.

19. The relay device as set forth in claim 8, wherein in a rest state of said actuator, only one of said at least two contacts always contacts said conductive fluid, and in an active state of said actuator, said conductive fluid moves into said fluid channel to form the conductive state between said contacts.

20. The relay device as set forth in claim 8, wherein in a rest state of said actuator, the conductive state between said contacts are kept by said conductive fluid, and in an active state of said actuator, said conductive fluid moves into said fluid channel to detach said conductive fluid from one of said contacts, thereby forming the non-conductive state between said contacts.

21. The relay device as set forth in claim 1, wherein said laminate comprises a fluid storage portion which said diaphragm portion faces, and said at least two contacts are disposed in fluid storage portion, and wherein a positional displacement of said conductive fluid in said fluid storage portion is caused by the elastic deformation of said diaphragm portion, thereby forming the conductive state or the non-conductive state between said contacts.

22. The relay device as set forth in claim 21, wherein said diaphragm portion is configured in a substantially circular shape.

23. The relay device as set forth in claim 1, wherein said laminate has said interior space comprising a fluid storage portion that said diaphragm portion faces, which is configured to accommodate said conductive fluid, a second fluid storage portion formed away from said fluid storage portion to accommodate said conductive fluid, and a fluid channel coupling between said fluid storage portion and said second fluid storage portion;
said at least two contacts comprises a pair of contacts located in said fluid channel within a predetermined range from said fluid storage portion, and another pair of contacts located in said fluid channel within a predetermined range from said second fluid storage portion;
wherein in an active state of said actuator for elastically deforming said diaphragm portion, the relay device provides forming the conductive state between said pair of contacts by use of said conductive fluid provided from said fluid storage portion, and keeping the non-conductive state between said another pair of contacts, and
wherein in a rest state of said actuator, the relay device provides forming the conductive state between said another pair of contacts by use of said conductive fluid provided from said second fluid storage portion, and keeping the non-conductive state between said pair of contacts.
